(19) United States
(12) Patent Application Publication
(10) Pub. No.: US 2025/0243008 A1
(43) Pub. Date: Jul. 31, 2025

(54) DEVICE FOR DETERMINING THE ELONGATION OF A CHAIN AND ASSOCIATED CONVEYOR AND METHOD

(71) Applicant: AKTIEBOLAGET SKF, GOTEBORG (SE)

(72) Inventor: Phillip HEWITT, Utrecht (NL)

(21) Appl. No.: 19/012,131

(22) Filed: Jan. 7, 2025

(30) Foreign Application Priority Data
Jan. 25, 2024 (DE) 102024200675.0

(51) Int. Cl. B65G 43/02; B65G 17/00

(52) U.S. Cl. CPC B65G 43/02; B65G 17/00; B65G 2203/043; B65G 2811/095

(57) ABSTRACT

A method for determining a chain elongation value of a conveyor chain comprising driving a conveyor at a first speed via the conveyor chain when the conveyor chain is in an initial condition, using a sensor to detect first and second times at which first and second target elements arranged on pins of the chain pass the sensor, determining a difference between the first and second times as a reference duration, performing the same measuring steps when the conveyor is operating under load at a second speed to determine a first duration, and determining the chain elongation value from the first duration and the reference duration. Also a device for performing the method.

### CROSS-REFERENCE

This application claims priority to German patent application no. 10 2024 200 675.0 filed on Jan. 25, 2024, the contents of which are fully incorporated herein by reference.

### TECHNOLOGICAL FIELD

The present disclosure is directed to a method and device for determining a chain elongation value of a chain, in particular a chain of a conveyor such as a conveyor belt, in order to determine wear of the chain.

### BACKGROUND

It is known that the elongation of a chain is representative of the wear of the chain. When an elongation amount or value of a conveyor chain has reached a predetermined value, the chain is worn and needs to be replaced to avoid failure and breakage. The elongation value is determined by measuring a distance between two pins and comparing the measured distance with the distance between these two pins when the chain was new.

In order measure the distance between two pins, the conveyor driven by the chain needs to be shut down and the distance needs to be physically measured with a tool. Moreover, in order to plan preventive maintenance operations, the elongation value of the chain needs to be determined many times. Because the conveyor is stopped each time when the elongation value of the chain is determined, the productivity of the conveyor is decreased.

### SUMMARY

Consequently, the present disclosure is directed to a method and apparatus for monitoring the wear of a conveyor chain without stopping the conveyor.

A method according to the disclosure includes: during an initialization step following the installation of the chain in the conveyor when the conveyor is driven by driving means of the conveyor chain at a predetermined speed: detecting a first instant of passage of a target element arranged at a first end of a first pin of the chain in front of a sensor, detecting a second instant of passage of a second target element arranged at a first end of a second pin of the chain in front of the sensor and determining a reference duration between the first instant of passage and the second instant of passage. Then during a conveying step, following the initialization step, during which the conveyor chain moves the conveys at the predetermined speed: detecting a third instant of passage of the first target element in front of the sensor, detecting a fourth instant of passage of the second target element in front of the sensor, determining a first duration between the third instant of passage and the fourth instant of passage, and determining an elongation value of the chain from the first duration and the reference duration.

The method allows automated continuous determination of the elongation of the chain to predict the wear of the chain without requiring physical measurement of the chain so that the conveyor driven by the chain does not to be shut down and workers do not need to physically measure the chain.

The prediction of the wear of the chain enables maintenance operations to be planned to reduce the risk of chain failure or breakage which could damage the conveyor or injure workers working near the conveyor. Advantageously, the conveyor is unloaded and the conveyor/conveyor belt does not carry material during the initialization step.

Preferably, the first pin and the second pin are immediately adjacent to each other.

Advantageously, the value VE of the elongation of the chain is equal to:

$$VE = \frac{D 1 - Dref}{Dref}$$

where D1 is the first duration and Dref is the reference duration.

Advantageously, when the determined elongation value of the chain is equal to at least one predetermined warning elongation value of the chain, the method comprises delivering a warning signal to warn for potential failures of the conveyor chain.

In one embodiment, the first target element comprises a first magnet insert, the second target element comprises a second magnet insert and the sensor is a Hall effect sensor. Preferably, the first magnet insert comprises a through hole, a screw passing through the through hole of the first magnet insert and being engaged in a tapered hole at the first end of the first chain, and the second magnet insert comprises a through hole, a screw passing through the through hole of the second magnet insert and being engaged in a tapered hole at the first end of the second pin.

According to another aspect, a method is provided for determining a chain elongation value of a conveyor chain that includes: a) driving a conveyor at a first speed via the conveyor chain when the conveyor chain is in an initial condition, b) while driving the conveyor at the first speed, using a sensor to detect a first time at which a first target element arranged at a first end of a first pin of the conveyor chain passes the sensor, c) while driving the conveyor at the first speed, using the senor to detect a second time at which a second target element arranged at a first end of a second pin of the conveyor chain passes the sensor, d) determining as a reference duration a difference between the first time and the second time, e) after step d, using the conveyor to convey material at a second speed, f) while using the conveyor to convey the material at the second speed, using the sensor to detect a third time at which the first target element passes the sensor, g) while using the conveyor to convey the material at the second speed, using the sensor to detect a fourth time at which the second target element passes the sensor, h) determining as a first duration a difference between the third time and the fourth time, and i) determining the chain elongation value from the first duration and the reference duration.

According to another aspect, a device for determining the elongation of a chain of a conveyor chain is provided. The device comprises: a first target element configured to be arranged at a first end of a first pin of the chain, a second target element configured to be arranged at a first end of a second pin of the chain, and a sensor configured to detect the passage of the first target element and the second target element when the chain is driven by driving means of the conveyor chain. Advantageously, the sensor is a magnetic sensor such as a Hall effect sensor. The device also includes first determining means configured to determine a reference duration between a first instant of passage of the first target element in front of the sensor and a second instant of passage of the second target element in front of the sensor and a first duration between a third instant of passage of the first target element in front of the sensor and a fourth instant of passage of the second target element in front of the sensor and second determining means configured to determine an elongation value of the chain from the first duration and the reference duration determined by the first determining means.

Preferably, the device further comprises warning means configured to deliver a warning signal to warn of potential failures of the conveyor chain when the determined elongation value of the chain is equal to at least one predetermined warning elongation value of the chain.

According to another aspect, a conveyor that includes the conveyor chain is disclosed. The conveyor comprises a chain having a plurality of pins and a device as defined above. The first target element is arranged at a first end of a first pin of the plurality of pins and the second target element is arranged at a first end of a second pin of the plurality of pins.

### BRIEF DESCRIPTION OF THE DRAWINGS

Other advantages and features of the disclosure will appear on examination of the detailed description of embodiments, in no way restrictive, and the appended drawings in which:

FIG. 1 is a perspective view of a conveyor chain and a conveyor usable with an embodiment of the present disclosure.

FIG. 2 is a top view of part of the conveyor and chain of FIG. 1.

FIG. 3 is a longitudinal cross section of a pin of the chain of FIG. 1.

FIG. 4 is a flowchart schematically illustrating an example of a method for determining an elongation of a chain according to an embodiment of the present disclosure.

### DETAILED DESCRIPTION

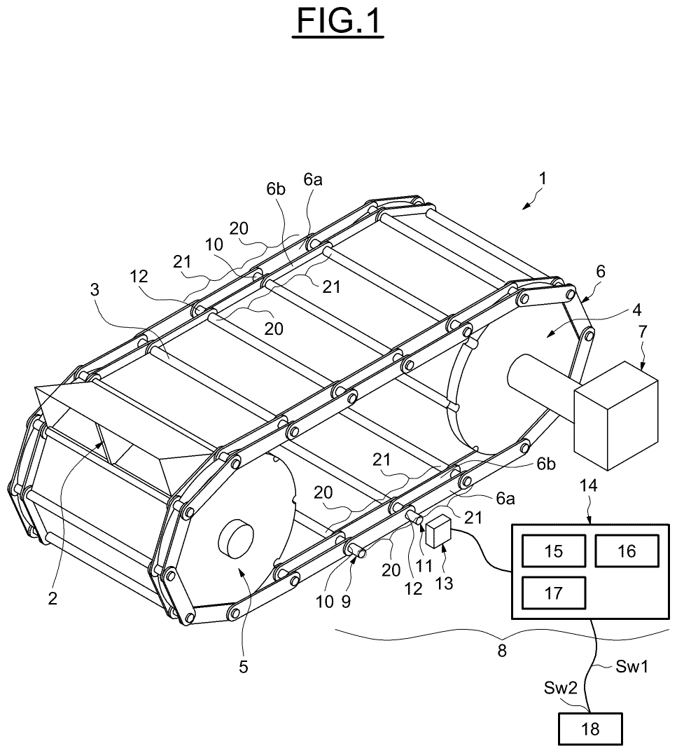

Reference is made to FIG. 1 which illustrates a conveyor 1 that includes buckets 2 connected together by pivoting connections 3. For clarity, only one bucket 2 is represented on the conveyor of FIG. 1.

The linked buckets 2 together form a loop extending between a pair of first gear wheels 4 and a pair of second gear wheels 5. Each of the chains 6 forms a loop that engages the teeth of the first gear wheels 4 and the second gear wheels 5 to drive the conveyor having the linked buckets 2.

The conveyor 1 further includes driving means 7, such as an electric motor, for driving the pair of first gear wheel 4.

Each chain 6 is formed by links 20, 21 connected together by pins 10, 12. Each link 20, 21 is formed by a first bar 6a and a second bar 6b parallel to the first bar 6a. Each bar 6a, 6b has a hole at each end, and a first pin 10 connects the holes at a first end of the bars 6a, 6b to connect the bars and a second pin 12 connects the holes at the second end of the bars 6a, 6b to connect the bars. The pins 10, 12 of the chain 6 are identical.

The conveyor chain 1 further comprises a system 8 for determining the elongation of the chain 6. The system 8 comprises a first target element 9 arranged at a first end of the first pin 10 of the chain 6 and a second target element 11 arranged at the first end of the second pin 12 of the chain 6. The first end of the first pin 10 and the first end of the second pin 12 may be on the same side of the chain 6 or on different sides of the chain 6.

The system 8 further comprises a sensor 13 configured to detect the passage of the first target element 9 and the passage of the second target element 11 when the chain 6 is driven by the driving means 7 of the conveyor chain 1. The sensor 13 is mounted laterally on the outside of the chain 6. The sensor 13 laterally faces the chain 6 and is fixed relative to the chain 6.

In this example, the first target element 9 comprises a first magnet insert, the second target element 11 comprises a second magnet insert, and the sensor 13 is a Hall effect sensor. In the illustrated example, the target elements 9, 11 and the sensor 13 use magnetic technology. Alternatively, the target elements and the sensor may use any other suitable technology than magnetic technology including without limitation, optical technology.

For example, in another embodiment, the first target element 9 may comprise a first reflective device, the second target element 11 may comprise a second reflective device and the sensor 13 may comprise a laser and an optical detector.

The system 8 further comprises a processing module 14 having first determining means 15, second determining means 16 and warning means 17. he first determining means 15 are intended to determine a reference duration Dref between a first instant of passage of the first target element 9 in front of the magnetic sensor 13 and a second instant of passage of the second target element 11 in front of the magnetic sensor 13.

As exposed in the following, the reference duration Dref is determined during an initialization step following the installation of the chain 6 in the conveyor when the chain is driven by driving means of the conveyor chain at a predetermined speed. The chain 6 is new (not worn).

The first determining means 15 are further intended to determine a first duration D1 between a third instant of passage of the first target element 9 in front of the sensor 13 and a fourth instant of passage of the second target element 11 in front of the sensor 13. The first determining means, and other determining means discussed hereinafter, may comprise a programmable hardware component such as a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

As described hereinafter, the first duration D1 is determined during a conveying step following the initialization step, when the conveyor chain carries material at the predetermined speed.

The elongation value of the chain 6 is determined by measuring the distance between two pins and comparing the measured distance with the distance between pins of a new chain. Therefore, when the chain 6 is driven at a predetermined constant speed, the reference duration Dref is representative of the distance between two pins when the chain 6 is new and the first duration D1 is representative of the distance between two pins of the chain 6 during a conveying operation.

The distance between two pins is equal to the reference duration Dref multiplied by the predetermined speed and the distance between two pins during a conveying step is equal to the first duration D1 multiplied by the predetermined speed.

The second determining means 16 are intended to determine the value VE of the elongation of the chain 6 from the first duration D1 and the reference duration Dref. The second determining means may be part of the same controller or microprocessor as the first determining means or a may be a separate component.

The value VE of the elongation of the chain 6 is equal to:

$$VE = \frac{D 1 - Dref}{Dref}$$

The warning means 17 are intended to deliver a warning signal to warn of potential failures of the conveyor chain 1 when the determined value VE of the elongation of the chain 6 is equal to at least one predetermined warning elongation value of the chain 6. The warning means may comprise, for example, a light, a speaker for producing a sound output or a circuit for sending a signal to a display or other output device to indicate that the value VE has reached the predetermined level. The warning means may also include suitable circuitry for generating a warning signal.

The warning signal is for example delivered to a human machine interface to warn an operator, for example a warning light. The warning signal may be delivered to a processing unit (not represented) for further processing.

For example, a first predetermined warning value and a second predetermined value bigger than the first predetermined value may be defined. The first predetermined warning value may be representative of a degree of wear suggesting a need to schedule a maintenance operation of the chain 6 and the second predetermined warning value may be representative of a degree of wear indicating a need for the imminent replacement of the chain 6. The first predetermined warning value may be equal to 2% and the second predetermined warning value may be equal to 3%.

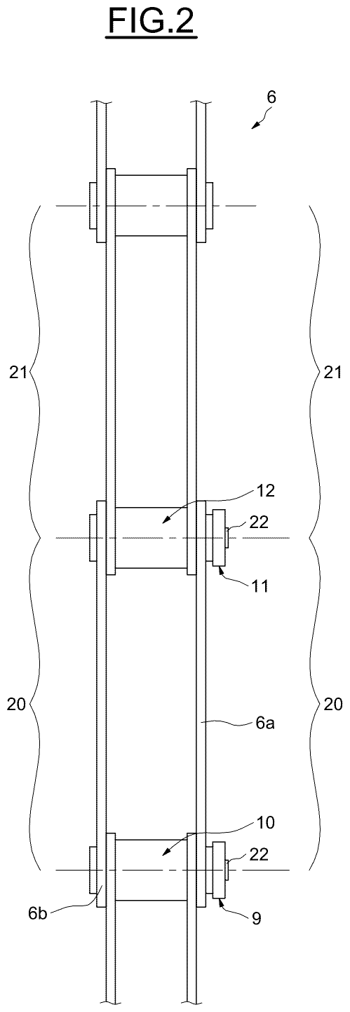

FIG. 2 illustrates schematically a partial view of an example of the chain 6. The chain 6 comprises the links 20, 21. The link 20 comprises the first and second pins 10, 12 and the first and second target elements 9, 11 are mounted to the first and second pins 10, 12. In another embodiment, the first and second target elements 9, 11 may be arranged on pins of two different links, the pins being adjacent.

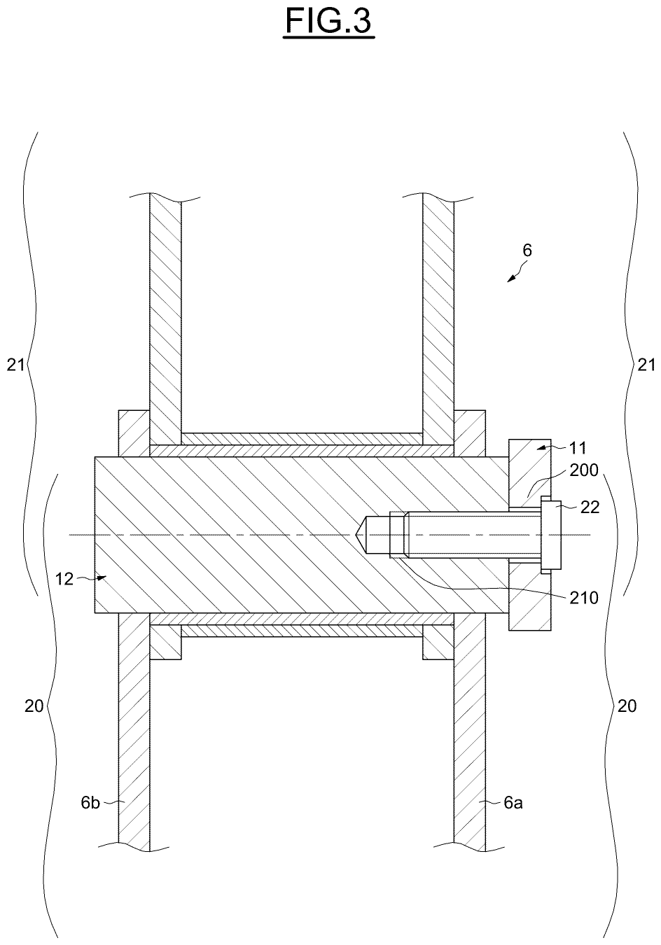

As previously mentioned, the first target element 9 comprises a first magnet insert, the second target element 11 comprises a second magnet insert and the sensor is a Hall effect sensor 13. Because the first magnet insert 9 and second magnet insert 11 are identical, FIG. 3 illustrates schematically a longitudinal cross section of the first pin chain 10 of the chain 6.

The second magnet insert 11 is arranged at the first end of the second pin 12. The second magnet insert 11 may be circular and include a through hole 200. The first end of the second pin 12 comprises a tapered hole 210.

A screw 22 passes through the through hole 200 of the second magnet insert 11 and is engaged in the tapered hole 210 of the first end of the second pin 12 to maintain the second magnet insert 11 on the first end of the second pin 12. Similarly, the first magnet insert 9 may be circular and may comprises a through hole, a screw passing through the through hole of the first magnet insert and being engaged in a tapered hole of the first end of the first pin 10 to maintain the first magnet insert 9 on the first end of the first pin 10.

The first magnet insert 9 and the second magnet insert 11 may be maintained on the pins of the chain 6 by other means, for example the first magnet insert 9 and the second magnet insert 11 may be glued on the pins of the chain 6.

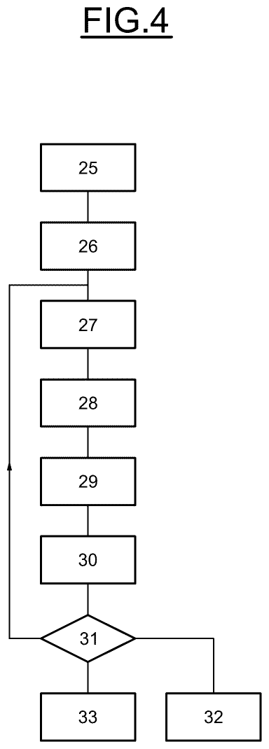

FIG. 4 illustrates schematically an example of a method for determining the elongation of the chain 6. The method is performed by the system 8.

During an initialization step 25 following the installation of the chain 6 in the conveyor 1, when the chain 6 is driven by the driving means 7 at the predetermined speed, the first determining means 15 detect the first instant of passage of the first target element 9 arranged at a first end of the first pin 10 in front of the sensor 13 from a signal delivered by the sensor 13 when the first target element 9 is in front of the sensor 13. Preferably, the conveyor 1 does not carry material during the initialization step and the chain is preferably new or at least in a condition in which it has not worn/elongated significantly.

Further during the initialization step 25, the first determining means 15 detect the second instant of passage of the second target element 11 arranged at a first end of the second pin 12 in front of the sensor 13 from a signal delivered by the sensor 13 when the second target element 11 is in front of the sensor 13. When the first determining means 15 have detected the first and second instants, the first determining means 15 determine the reference duration Dref in a step 26.

The predetermined speed is equal to the speed of the conveyor chain 1 when the conveyor chain 1 conveys material. The reference duration Dref is the duration between the first and the second instants at the predetermined speed when the chain 6 is new, not yet worn.

During a conveying step 27, following the initialization step 25, wherein the conveyor chain 1 conveys material at the predetermined speed, the first determining means 15 detect the third instant of passage of the first target element 9 arranged at a first end of the first pin 10 in front of the sensor 13 from a signal delivered by the sensor 13 when the first target element 9 is in front of the sensor 13. Further during the conveying step 27, the first determining means 15 detect the fourth instant of passage of the second magnet insert 11 arranged at a first end of the second pin 12 in front of the sensor 13 from a signal delivered by the sensor 13 when the second target element 11 is in front of the sensor 13. When the first determining means 15 have detected the third and fourth instants, the first determining means 15 determine the first duration D1 in a step 28.

In a step 29, the second determining means 16 determine the value VE of the elongation of the chain 6 from the first duration D1 and the reference duration Dref according to equation.

In a step 30, when the value VE of the elongation of the chain 6 is determined by the second determining means 16, the warning means 17 compare the value VE of the elongation of the chain 6 to the predetermined warning values. If the value VE of the elongation of the chain 6 is less than the first predetermined warning value (step 31), the method goes back to step 27.

If the value VE of the elongation of the chain 6 is greater than or equal to the first predetermined warning value (step 31) and smaller than the second predetermined warning value, in a step 32, the warning means 17 deliver a first warning signal Sw1 (FIG. 1) to warn of potential failures of the conveyor chain 1.

The human machine interface 18 receives the first warning signal Sw1 and may warn the operator that the elongation of the chain 6 is at least equal to the first predetermined warning value and that maintenance operation of the chain 6 should be scheduled.

If the value VE of the elongation of the chain 6 is greater than or equal to the second predetermined warning value (step 31), in a step 33, the warning means 17 deliver a second warning signal Sw2 (FIG. 1) to warn of potential failures of the conveyor chain 1.

The human machine interface 18 receives the second warning signal Sw2 and may warn the operator that the elongation of the chain 6 is at least equal to the second predetermined warning value and that the chain 6 should be replaced. After step 32, the method may go back to step 27. After step 33, the method may stop or go back to step 27.

The system 8 may comprise another magnetic sensor so that each magnetic sensor is intended to detect the passage of one of the first and second magnetic inserts.

The method allows automated continuous determination of an elongation value of the chain 6 to predict the wear of the chain 6 without requiring physical measurement of the chain 6 so that the conveyor chain 1 does not to be shut down and operatives do not need to physically measure the chain 6.

The prediction of the wear of the chain 6 enables maintenance to be planned for the chain 6 to reduce the risk of failure or breakage of the chain 6 which may damage the conveyor chain 1 or injure workers. Further, each of the two chains 6 may be monitored simultaneously, by providing each chain 6 with suitable target elements and sensors.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods and devices for determining an amount of elongation and thus of wear of a chain, such as a chain that drives a conveyor.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method for determining a chain elongation value of a conveyor chain comprising:
a) driving a conveyor at a first speed via the conveyor chain when the conveyor chain is in an initial condition,
b) while driving the conveyor at the first speed, using a sensor to detect a first time at which a first target element arranged at a first end of a first pin of the conveyor chain passes the sensor,
c) while driving the conveyor at the first speed, using the senor to detect a second time at which a second target element arranged at a first end of a second pin of the conveyor chain passes the sensor,
d) determining as a reference duration a difference between the first time and the second time,
e) after step d, using the conveyor to convey material at a second speed,
f) while using the conveyor to convey the material at the second speed, using the sensor to detect a third time at which the first target element passes the sensor,
g) while using the conveyor to convey the material at the second speed, using the sensor to detect a fourth time at which the second target element passes the sensor,
h) determining as a first duration a difference between the third time and the fourth time, and
i) determining the chain elongation value from the first duration and the reference duration.

2. The method according to claim 1,
wherein the material is not present on the conveyor during steps a-c, and
wherein the first speed is equal to the second speed.

3. The method according to claim 1,
wherein the first pin and the second pin are immediately adjacent to each other.

4. The method according to claim 1,
wherein the chain elongation value is denoted VE and VE calculated as:
$$VE = \frac{D 1 - Dref}{Dref}$$
where D1 is the first duration and Dref is the reference duration.

5. The method according to claim 1,
including producing a warning signal in response to a determination that the chain elongation value is greater than or equal to a predetermined value.

6. The method according to claim 1,
wherein the first target element comprises a first magnet assembly, the second target element comprises a second magnet assembly and the sensor is a Hall effect sensor.

7. The method according to claim 6,
wherein the first magnet assembly comprises:
a first magnet having a through hole,
a first screw passing through the through hole of the first magnet and engaging in a tapered hole in the first end of the first pin, and
wherein the second magnet assembly comprises:
a second magnet having a second through hole, a second screw passing through the second through hole of the second magnet and engaging in a tapered hole in the first end of the second pin.

8. A device for determining a chain elongation value of a conveyor chain comprising:
a first target element configured to be arranged at a first end of a first pin of the conveyor chain,
a second target element configured to be arranged at a first end of a second pin of the conveyor chain,
a sensor configured to detect a passage of the first target element and the second target element when the chain is driven,
first determining means for determining a reference duration between a first time at which the first target element passes the sensor and a second time at which the second target element passes the sensor and a first duration between a third time at which the first target element passes the sensor and a fourth time at which the second target element passes the sensor, and
second determining means for determining the chain elongation value from the first duration and the reference duration.

9. The device according to claim 8, further comprising:
warning means for producing a warning signal in response to a determination that the chain elongation value is greater than or equal to a predetermined value.

10. The device according to claim 9,
wherein the first target element comprises a first magnet assembly, the second target element comprises a second magnet assembly and the sensor is a Hall effect sensor,
wherein the first magnet assembly comprises a first magnet having a through hole, a first screw passing through the through hole of the first magnet and engaging in a tapered hole in the first end of the first pin, and
wherein the second magnet assembly comprises a second magnet having a second through hole, a second screw passing through the second through hole of the second magnet and engaging in a tapered hole in the first end of the second pin.

11. A conveyor comprising:
a chain having a first pin and a second pin, and
a device according to claim 10,
wherein the first target element is mounted on the first end of the first pin and the second target element is mounted at the first end of the second pin.

12. A conveyor comprising:
a chain having a first pin and a second pin, and
a device according to claim 8,
wherein the first target element is mounted on the first end of the first pin and the second target element is mounted at the first end of the second pin.
